(19) United States
(12) Patent Application Publication
(10) Pub. No.: US 2004/0155545 A1
(43) Pub. Date: Aug. 12, 2004

(54) Switched reluctance motor having improved stator pole design

(76) Inventors: Martin Kaplan, Avon, CT (US); James M. Kokernak, Niskayuna, NY (US)

Correspondence Address: DYKEMA GOSSETT PLLC, 39577 WOODWARD AVENUE, SUITE 300, BLOOMFIELD HILLS, MI, 48304-5086, US

(21) Appl. No.: 10/360,111

(22) Filed: Feb. 6, 2003

(51) Int. Cl. H02P 15/00

(52) U.S. Cl. 310/110

(57) ABSTRACT

A switched reluctance motor is provided that optimizes the available space between adjacent stator poles for conductors. The inventive motor includes a rotor having a plurality of radially outwardly extending poles and a stator disposed about the rotor. The stator includes an back iron and a plurality of poles extending radially inwardly from the back iron. The stator poles taper radially inwardly from the back iron to a radially innermost portion The adjacent sides of any two stator poles are parallel or are angled up to about five degrees relative to positions the sides would occupy if they were parallel.

### BACKGROUND OF THE INVENTION

1. Field of the Invention

This invention relates to switched reluctance motors and, in particular, to the design of the stator poles of a switched reluctance motor.

2. Discussion of Related Art

A conventional switched reluctance motor includes a rotor having a plurality of pairs of diametrically opposed rotor poles and a stator having a plurality of pairs of diametrically opposed stator poles. Windings or coils are typically disposed about the stator poles and the windings around any two diametrically opposed stator poles may be connected in series or in parallel to define one motor phase of the multiphase switched reluctance motor. The windings associated with a motor phase may be referred to as a phase coil. By generating current through the phase coil, magnetic fields are established about the stator poles and a torque is produced that attracts a pair of rotor poles into alignment with the stator poles. The current in the phase coils is generated in a predetermined sequence in order to produce a constant torque on the rotor.

The stator poles on many conventional switched reluctance motors have a relatively constant width. As a result, the slot between any two adjacent poles is widest near the back iron of the stator and narrows as the poles move radially inwardly. Accordingly, the gap between adjacent stator poles at their radially innermost extent limits the size of the winding or conductor that may be inserted around the stator. Further, because the slot between adjacent stator poles widens at the radially outermost extent of the poles while the diameter of the winding around the poles generally remains constant, a large amount of space remains empty and does not contribute electrically or magnetically to the function of the motor. Another deficiency of the described stator pole involves the saturation associate with typical switched reluctance motor operation. With the stator pole sides parallel, the pole cross-section is constant in the radial direction. Saturation will occur uniformly throughout the stator pole if it occurs at all thereby increasing magnetic reluctance.

The inventors herein have recognized a need for a switched reluctance motor that will minimize and/or eliminate one or more of the above-identified deficiencies.

### SUMMARY OF THE INVENTION

The present invention provides a switched reluctance motor having an improved stator pole design.

A motor in accordance with the present invention includes a rotor having a plurality of radially outwardly extending rotor poles and a stator disposed about the rotor. The stator has a back iron and a plurality of stator poles extending radially inwardly from the back iron. In accordance with one embodiment of the invention, a first stator pole of the plurality of stator poles tapers radially inwardly from the back iron of the stator to a radially innermost portion of the first stator pole and a second stator pole of the plurality of stator poles also tapers radially inwardly from the back iron of the stator to a radially innermost portion of the second stator pole. The second stator pole is adjacent to the first stator pole and a first side of the first stator pole and a first side of the second stator pole are adjacent to one another. Each are angled between zero and about five degrees relative to positions the first sides of the first and second stator poles would occupy if the first sides of the first and second stator poles were parallel to one another. Zero degrees represents the condition where the first side of the first stator pole and the first side of the second stator pole are parallel. In accordance with another embodiment of the invention, first and second adjacent stator poles of the plurality of stator poles each include a body portion and a radially innermost tip portion. The body and tip portions of the first and second stator poles taper. A first side of the body and tip portions of the first stator pole and a first side of the body and tip portions of the second stator pole are adjacent to one another and are angled between zero and about five degrees relative to positions the first sides of the body and tip portions of the first and second stator poles would occupy if the first sides of the body and tip portions of the first and second stator poles were parallel to one another.

A switched reluctance motor in accordance with the present invention is advantageous. The design of the stator poles in the inventive motor results in a slot gap between adjacent stator poles that is uniform or nearly uniform in width from the perspective of looking radially inward from the back iron of the stator. As a result, the width of the slot at the most radially inward position is not significantly smaller than the width of the slot at the most radially outward position and does not limit the conductor fill of the slot. This advantage allows a larger percentage of the overall slot volume to be occupied by conductive material thereby increasing the performance of the machine. Another advantage of the inventive motor is that the smallest radial cross-section area of the stator poles is located at the radially innermost portion of the poles. Saturation will occur in these portions first thereby limiting the saturation that occurs in the remaining portions of the stator pole and further improving motor performance by decreasing magnetic reluctance.

These and other advantages of this invention will become apparent to one skilled in the art from the following detailed description and the accompanying drawings illustrating features of this invention by way of example.

### BRIEF DESCRIPTION OF THE DRAWINGS

FIG. 1 is an exploded perspective view of a switched reluctance motor in accordance with one embodiment of the present invention.

FIG. 2 is a cross-sectional view of the switched reluctance motor of FIG. 1.

FIG. 3 is an enlarged view of a portion of the switched reluctance motor of FIGS. 1 and 2.

FIG. 4 is an enlarged view of a portion of a switched reluctance motor in accordance with a second embodiment of the present invention.

### DETAILED DESCRIPTION OF EMBODIMENTS OF THE INVENTION

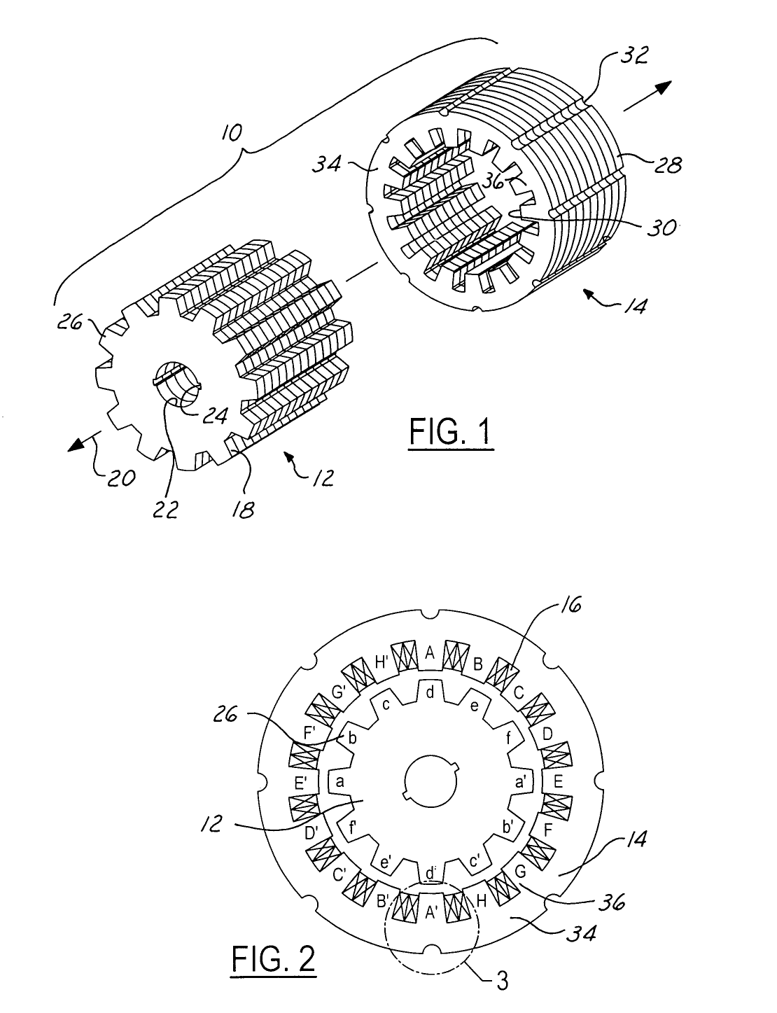

Referring now to the drawings wherein like reference numerals are used to identify identical components in the various views, FIGS. 1 and 2 illustrate a switched reluctance motor 10 in accordance with one embodiment of the present invention. Motor 10 includes a rotor 12, a stator 14, and a plurality of windings 16.

Rotor 12 is provided impart rotary motion to a load (not shown). Rotor 12 may be comprise of a plurality of laminations 18 made from a magnetically permeable material (i.e., a material having a relatively low magnetic reluctance) such as iron. Rotor 12 is disposed and centered about an axis 20 and defines a bore 22 through which a motor shaft (not shown) extends for connection to the load. Rotor 12 may be coupled to the shaft for rotation therewith in a conventional manner such as by using corresponding keyways 24 formed in rotor 12 and corresponding keys (not shown) formed on the motor shaft. Rotor 12 is capable of both clockwise and counterclockwise rotation. Rotor 12 defines a plurality of radially outwardly extending rotor poles 26 configured as diametrically opposed rotor pole pairs a-a′, b-b′, c-c′, d-d′, e-e′, and f-f′. Each pole 26 may be generally rectangular in cross-section and symmetrical about a radially extending line bisecting the pole 26. Each pole 26 may also taper as it extends radially outward and may include one or more radially outwardly extending teeth as is known in the art. In the illustrated embodiment, rotor 12 includes twelve rotor poles 26 and the angular distance from the center of one pole 26 to an adjacent pole 26 is about thirty (30) degrees. It should be understood, however, that the number of poles 26 may vary.

Stator 14 is provided to produce a torque to cause rotation of rotor 12. Stator 14 may also comprise a plurality of laminations 28 made from a magnetically permeable material (i.e., a material having a relatively low magnetic reluctance) such as iron. Stator 14 is disposed and centered about axis 20 and defines a bore 30 sized to receive rotor 12 such that stator 14 is disposed about rotor 12. Stator 14 may also define a plurality of circumferentially spaced recesses 32 configured to receive bolts, pins or other fasteners (not shown) for mounting stator 14 to a fixed object. Stator 14 defines a back iron 34 which is annular in the illustrated embodiment and a plurality of stator poles 36 extending radially inwardly from back iron 34 and configured as diametrically opposed stator pole pairs A-A′, B-B′, C-C′, D-D′, E-E′, F-F′, G-G′, and H-H′. In the illustrated embodiment, stator 14 includes sixteen stator poles 36 and the angular distance from the center of one pole 36 to an adjacent pole 36 is about twenty two and one half (22.5) degrees. It should be understood, however, that the number of poles 36 may vary.

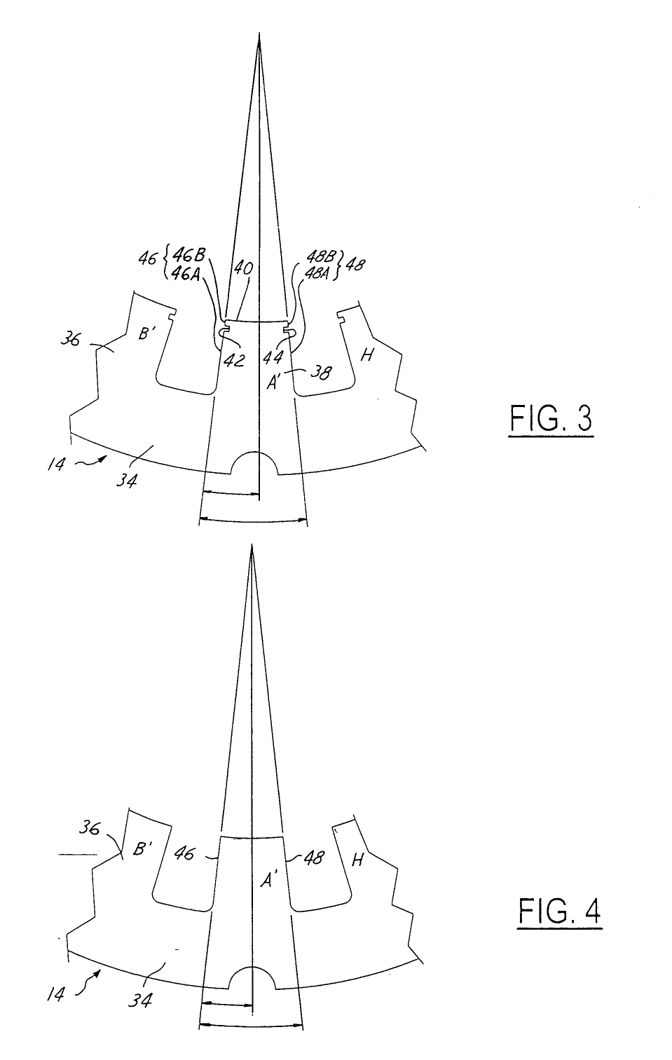

Referring now to FIG. 3, stator poles 36 will be described in greater detail. Each pole 36 may be symmetrical about a radially extending line bisecting the pole 36. Each pole 36 may include a body portion 38 and a tip or tooth portion 40. Portions 38, 40 may be integral so as to form a unitary member. An axially extending notch 42, 44 may be formed on either radially extending side 46, 48, respectively, of each pole 36 to secure windings 16. In accordance with the present invention, each pole 36 tapers as it extends radially inwardly from back iron 34 such that sides 46, 48 of each pole 36 approach each other. In particular, in the embodiment illustrated in FIGS. 1-3, the body portion 38 and tip portion 40 of each pole 36 both taper as pole 36 extends radially inwardly from back iron 34. Further, both the body portion 38 and tip portion 40 of each pole may taper at the same angle although it should be understood that the body and tip portions may taper at different angles.

In accordance with the present invention the sides 46A, 46B and 48A, 48B of adjacent stator poles 36 such as stator pole A′ and stator pole B′ are angled between zero and about five degrees relative to the positions sides 46A, 46B and 48A, 48B of body and tip portions 38, 40 of adjacent stator poles A′, B′ would occupy if sides 46A, 46B and 48A, 48B of body and tip portions 38, 40 of stator poles A′, B′ were parallel to one another. In other words, side 46A of body portion 38 of stator pole A′ is parallel to side 48A of body portion 38 of stator pole B′ or sides 46A, 48A of poles A′, B′ are each angled no more than about five degrees relative to the parallel orientation. Similarly, side 46B of tip portion 40 of stator pole A′ is parallel to side 48B of tip portion 40 of stator pole B′ or sides 46B, 48B of poles A′, B′ are each angled no more than about five degrees relative to the parallel orientation. Stated another way, body portion 38 of each pole 36 spans an angular distance proximate the back iron 34 between a first angular distance in which adjacent sides 46A, 46B of adjacent stator poles 36 (such as A′ and B′) extend parallel to one another and a second angular distance of about ten degrees less than the first angular distance. Similarly, tip portion 40 of each pole 36 spans an angular distance between a first angular distance in which adjacent sides 48A, 48B of adjacent stator poles (such as A′ and B′) extend parallel to one another and a second angular distance of about ten degrees greater than the first angular distance. It should be understood that the specific angular degrees set forth herein for the angle of sides 46A, 48A, 46B, 48B relative to a parallel orientation and the angular span of body portion 38 and tip portion 40 are maximum values. For motors having a greater number of stator poles, the maximum tapering angle of the sides of the poles would be less than five degrees relative to a parallel orientation and the body and tip portions of the stator poles would span angular distances between a first angular distance in which adjacent sides of adjacent stator poles extend parallel to one another and a second angular distance less than about ten degrees greater than the first angular distance.

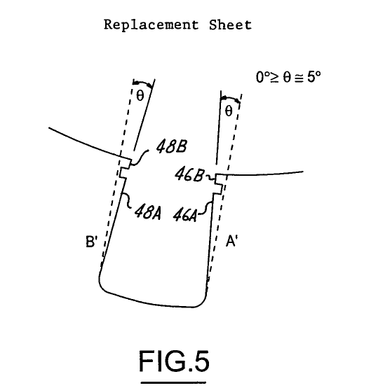

Referring now to FIG. 4, in a second embodiment of the present invention, each stator pole 36′ tapers continuously from back iron 34 to a radially innermost portion of each pole 36′. In other words, stator poles 36′ are substantially similar to stator poles 36, but do not include the axially extending notches 42, 44 found in poles 36. In accordance with the present invention, the adjacent sides 46′, 48′ of adjacent stator poles 36—such as poles A′ and B′—are again each angled between zero and about five degrees relative to positions the sides 46′, 48′ of poles A′, B′ would occupy if sides 46′, 48′ of stator poles A′, B′ were parallel to one another.

The design of stator poles 36, 36′ represents a significant improvement over the prior art. The design of poles 36, 36′ results in a slot gap between adjacent stator poles 36, 36′ that is uniform or nearly uniform in width as the poles move radially inwardly from the back iron 34 of the stator 14. As a result, larger size or additional conductors may be inserted in the slot gaps between adjacent poles 36, 36′ and little if any space in the slot gap is wasted thereby optimizing electromagnetic performance of the motor 10.

Referring again to FIGS. 1-2, windings 16 are provided to generate an electromagnetic field around select stator poles 36 or 36′. The windings 16 on diametrically opposite stator poles 36, 36′ may be connected in series or in parallel to form phase coils. Rotation of rotor 12 is produced by initiating, and later commutating, in a predetermined sequence, conduction cycles in the phase coils surrounding each stator pole pair. As one of phase coils begins to conduct current, the nearest rotor pole pair is magnetically attracted towards the stator pole pair around which the energized phase coil is wound. By initiating and commutating conduction cycles in phase coils surrounding consecutive stator pole pairs, a relatively constant torque can be produced.

While the invention has been shown and described with reference to one or more particular embodiments thereof, it will be understood by those of skill in the art that various changes and modifications can be made without departing from the spirit and scope of the invention.

We claim:

1. A switched reluctance motor, comprising:
a rotor having a plurality of radially outwardly extending rotor poles; and,
a stator disposed about said rotor, said stator having a back iron and a plurality of stator poles extending radially inwardly from said back iron
wherein a first stator pole of said plurality of stator poles tapers radially inwardly from said back iron of said stator to a radially innermost portion of said first stator pole and a second stator pole of said plurality of stator poles tapers radially inwardly from said back iron of said stator to a radially innermost portion of said second stator pole, said second stator pole adjacent said first stator pole, and a first side of said first stator pole and a first side of said second stator pole are adjacent to one another and are each angled between zero and about five degrees relative to positions said first sides of said first and second stator poles would occupy if said first sides of said first and second stator poles were parallel to one another.

2. The switched reluctance motor of claim 1 wherein said rotor and said stator are each formed from a plurality of laminations of magnetically permeable material.

3. The switched reluctance motor of claim 1, further comprising a first phase coil disposed about said first stator pole and defining a first motor phase of said motor and a second phase coil disposed about said second stator pole and defining a second motor phase of said motor.

4. The switched reluctance motor of claim 1 wherein each one of said first and second stator poles is diametrically opposite another stator pole of said plurality of stator poles.

5. The switched reluctance motor of claim 1 wherein said first stator pole is symmetrical about a line bisecting said first stator pole.

6. The switched reluctance motor of claim 1 wherein said first side of said first stator pole and said first side of said second stator pole are parallel to one another.

7. The switched reluctance motor of claim 1 wherein said rotor includes twelve of said rotor poles and said stator includes sixteen of said stator poles.

8. A switched reluctance motor, comprising:
a rotor having a plurality of radially outwardly extending rotor poles; and,
a stator disposed about said rotor, said stator having an back iron and a plurality of stator poles extending radially inwardly from said back iron
wherein first and second adjacent stator poles of said plurality of stator poles each include a body portion and a radially innermost tip portion that taper, a first side of said body and tip portions of said first stator pole and a first side of said body and tip portions of said second stator pole adjacent to one another and angled between zero and about five degrees relative to positions said first sides of said body and tip portions of said first and second stator poles would occupy if said first sides of said body and tip portions of said first and second stator poles were parallel to one another.

9. The switched reluctance motor of claim 8 wherein said rotor and said stator are each formed from a plurality of laminations of magnetically permeable material.

10. The switched reluctance motor of claim 8, further comprising a first phase coil disposed about said first stator pole and defining a first motor phase of said motor and a second phase coil disposed about said second stator pole and defining a second motor phase of said motor.

11. The switched reluctance motor of claim 9 wherein each one of said first and second stator poles is diametrically opposite another stator pole of said plurality of stator poles.

12. The switched reluctance motor of claim 8 wherein said first stator pole is symmetrical about a line bisecting said first stator pole.

13. The switched reluctance motor of claim 8 wherein said first side of said body and tip portions of said first stator pole and said first side of said body and tip portions of said second stator pole are parallel to one another.

14. The switched reluctance motor of claim 8 wherein said rotor includes twelve of said rotor poles and said stator includes sixteen of said stator poles.

15. A switched reluctance motor, comprising:
a rotor having a plurality of radially outwardly extending rotor poles; and,
a stator disposed about said rotor, said stator having an back iron and a plurality of stator poles extending radially inwardly from said back iron
wherein each stator pole of said plurality of stator poles includes a body portion and a radially innermost tip portion that taper, first and second sides of said body and tip portions of each stator pole of said plurality of stator poles angled between zero and about five degrees relative to a position said first and second sides of said body and tip portions would occupy if said first and second sides of said body and tip portions were parallel to adjacent sides of body and tip portions of adjacent stator poles of said plurality of stator poles.

16. The switched reluctance motor of claim 15 wherein said rotor and said stator are each formed from a plurality of laminations of magnetically permeable material.

17. The switched reluctance motor of claim 15, further comprising a plurality of phase coils defining a plurality of motor phases of said motor, each of said plurality of phase coils disposed about at least one of said plurality of stator poles.

18. The switched reluctance motor of claim 15 wherein each one of said plurality of stator poles is diametrically opposite another stator pole of said plurality of stator poles.

19. The switched reluctance motor of claim 15 wherein each one of said plurality of stator poles is symmetrical about a line bisecting said one stator pole.

20. The switched reluctance motor of claim 1 wherein said first side of said first stator pole and said first side of said second stator pole are parallel to one another.
